(19) United States
(12) Patent Application Publication
(10) Pub. No.: US 2011/0048647 A1
(43) Pub. Date: Mar. 3, 2011

(54) Tape cutter blade with truncated trapezoidal sharpened teeh

(76) Inventor: YU CHIN LIU, TAICHUNG (TW)

(21) Appl. No.: 12/689,244

(22) Filed: Jan. 19, 2010

(30) Foreign Application Priority Data
Sep. 2, 2009 (TW) 98216155

(51) Int. Cl. B32B 38/04

(52) U.S. Cl. 156/527

(57) ABSTRACT

A tape cutter blade has truncated trapezoidal sharpened teeth and a substantially triangular gap is formed between any two adjacent teeth. The sharpened teeth are capable of leaving uniform teeth on the severed end of a cut out portion of an adhesive tape after application of the tape. This has the benefits of being visually attractive, easy of applying the adhesive side of the tape onto an object to be sealed, and capable of cutting out adhesive tapes formed of foam or fiber.

### BACKGROUND OF THE INVENTION

1. Field of Invention

The invention relates to tape cutting devices and more particularly to a blade of a tape cutter, the blade having truncated trapezoidal sharpened teeth capable of leaving uniform teeth on the severed end of a cut out portion of an adhesive tape after application of the tape.

2. Description of Related Art

A conventional blade 11 of a tape cutter is shown in FIGS. 1 and 2. The blade 11 is releasably secured to a sliding blade mount 10. The rectangular blade 11 has triangular sharpened teeth 12 on one exposed end. It is supposed that a cut out portion 20 of an adhesive tape after application of the tape should be looked like one shown in FIG. 2.

However, in fact the severed end of the cut out portion 20 of an adhesive tape after application of the tape is looked like one shown in FIG. 3. It is seen that the severed end of the cut out portion 20 of an adhesive tape is irregular and uneven. Disadvantageously, this is ugly. Further, it can hinder a subsequent application. This is because the construction of the prior art tape cutter blade 11 does not consider the resilient nature of an adhesive tape and has triangular sharpened teeth 12 which is not capable of smoothly guiding severed end of the cut out portion 20. Furthermore, such tape cutter blade 11 may have great difficulties of cutting out adhesive tapes formed of foam or fiber. Thus, the need for improvement still exists.

### SUMMARY OF THE INVENTION

It is therefore one object of the invention to provide a tape cutter blade having truncated trapezoidal sharpened teeth. A triangular gap is formed between any two adjacent teeth. The sharpened teeth are capable of leaving uniform teeth on the severed end of a cut out portion of an adhesive tape after application of the tape.

The above and other objects, features and advantages of the invention will become apparent from the following detailed description taken with the accompanying drawings.

### BRIEF DESCRIPTION OF THE DRAWINGS

FIG. 1 is a perspective view of a conventional tape cutter blade to be assembled with a sliding blade mount of the tape cutter;

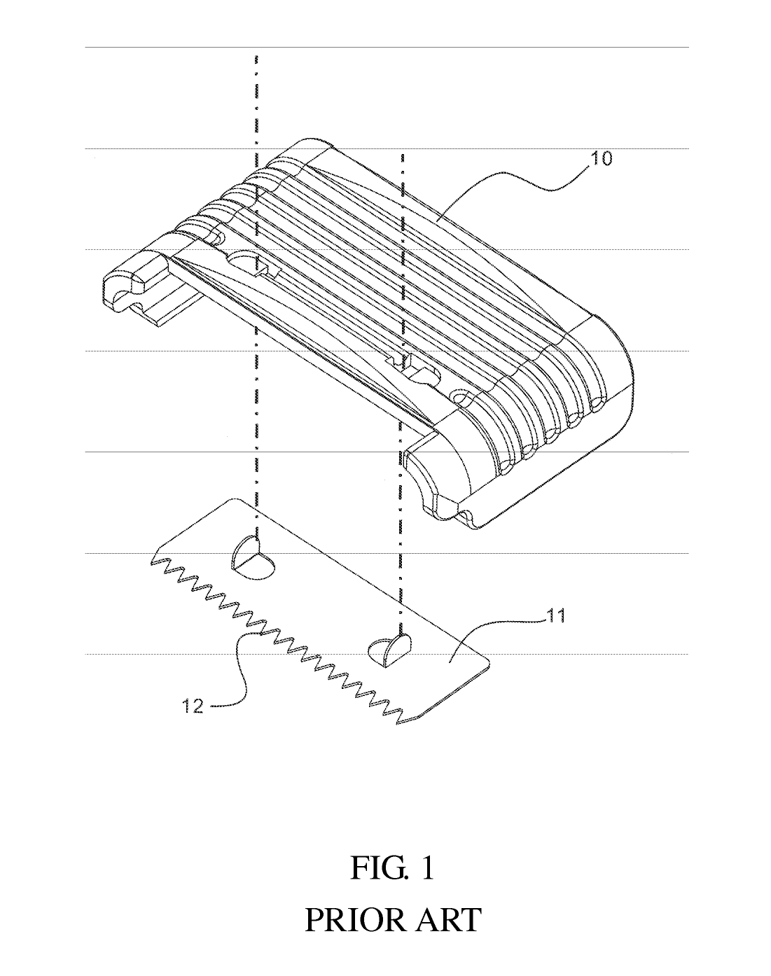

FIG. 2 is a top plan view of the blade and an ideal cut out portion of an adhesive tape after application of the tape formed by means of the blade;

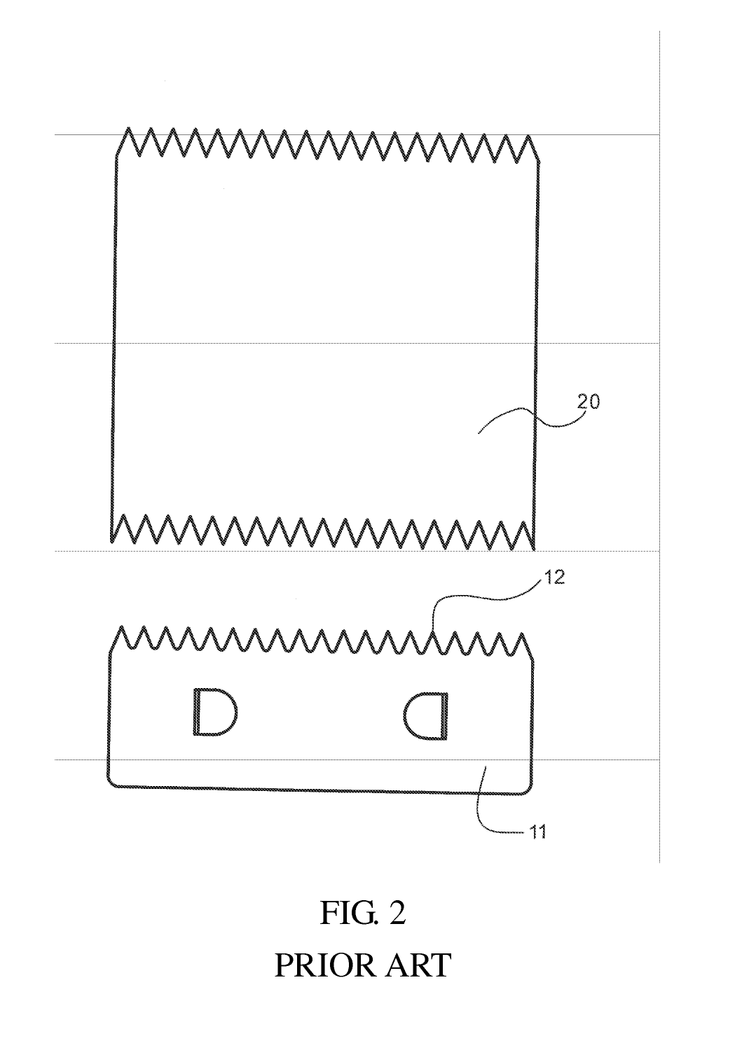

FIG. 3 is a perspective view of the cut out portion of an adhesive tape in fact;

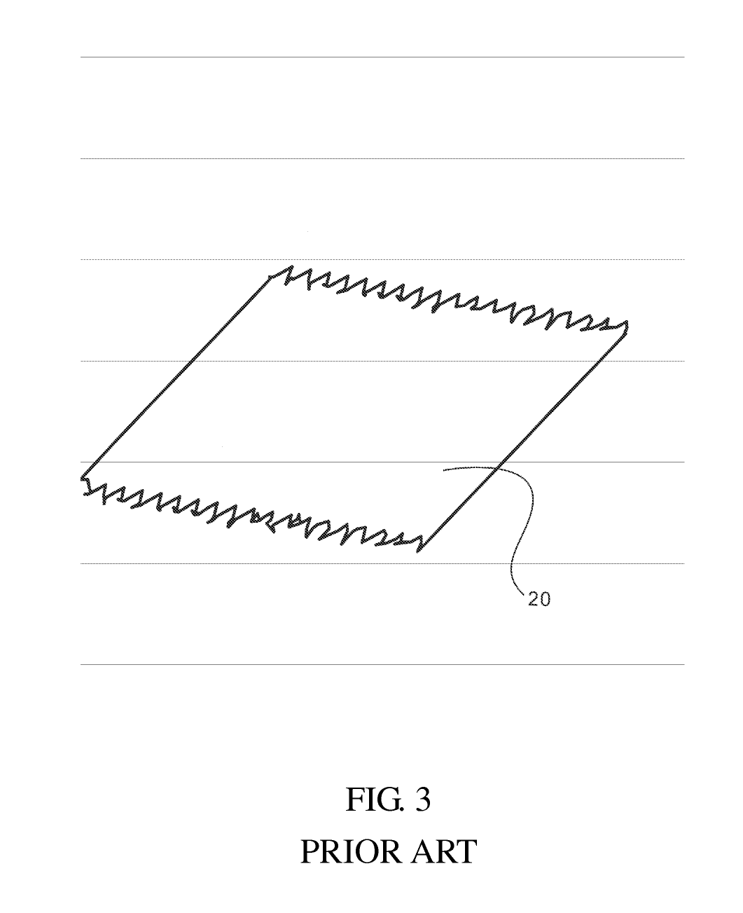

FIG. 4 is an exploded view of a tape cutter incorporating a preferred embodiment of blade according to the invention;

FIG. 5 is a perspective view of the assembled tape cutter shown in FIG. 4 with the free end of an adhesive tape being exposed in a cutter opening in an operative applying position;

FIG. 6 is a perspective view of the blade shown in FIG. 4 to be assembled with the sliding blade mount;

FIG. 7 is a fragmentary perspective view of the assembled blade and the sliding blade mount and other parts of the tape cutter with a desired length of an adhesive tape being pulled out of a cutter opening;

FIG. 8 is a side elevation of the tape cutter of the invention where the tape has been cut;

FIG. 9 is a top plan view of the blade and a cut out portion of the tape after application of the tape formed by means of the blade of the invention; and

FIG. 10 is a perspective view of the cut out portion of the tape shown in FIG. 9.

### DETAILED DESCRIPTION OF THE INVENTION

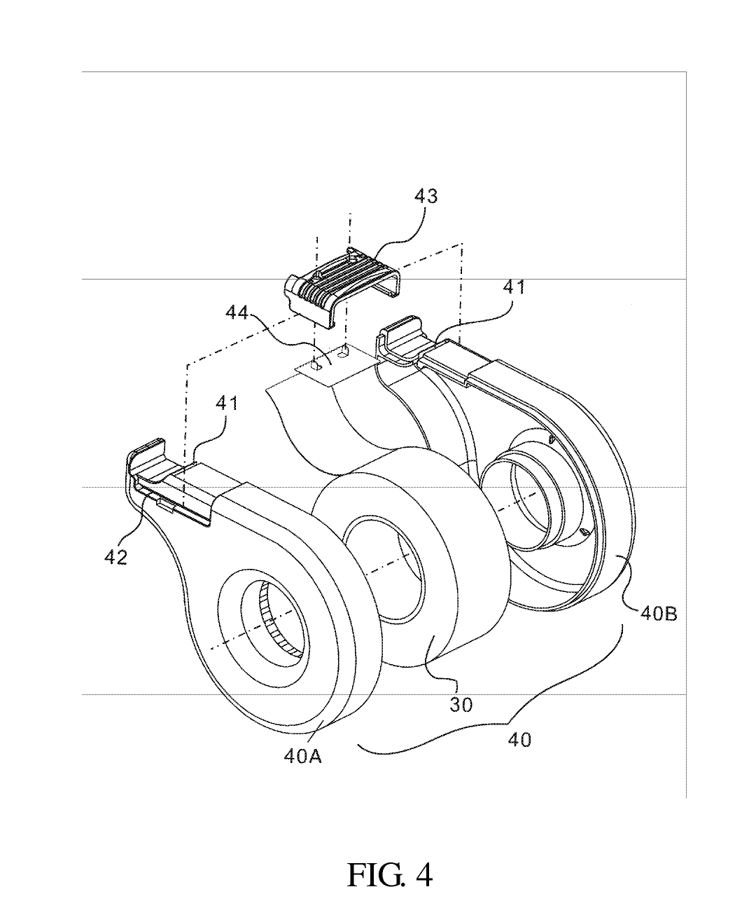

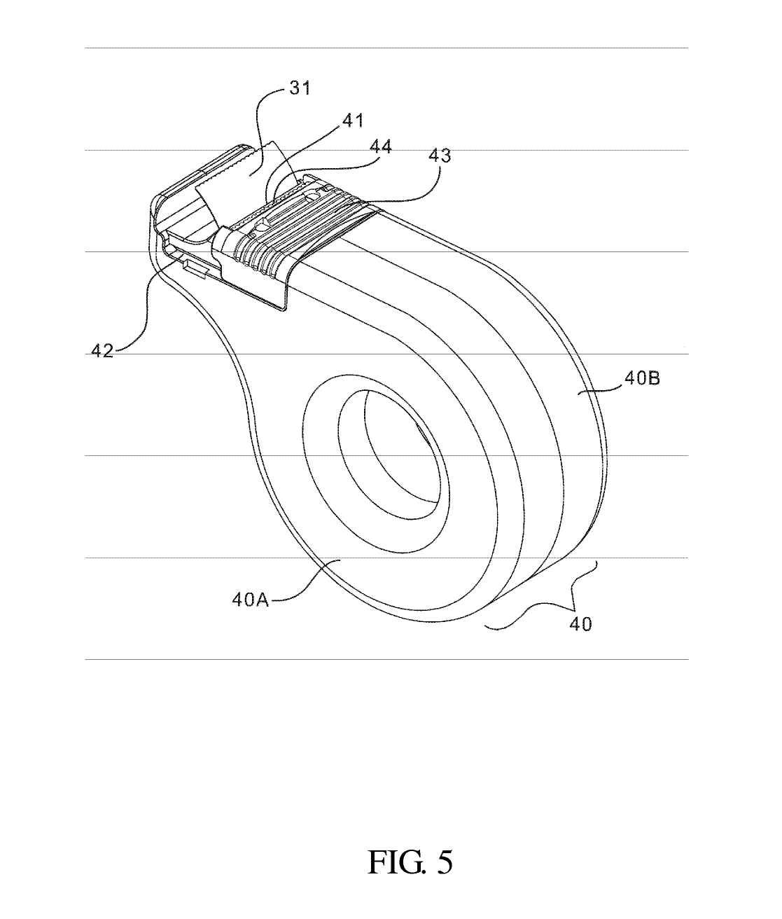

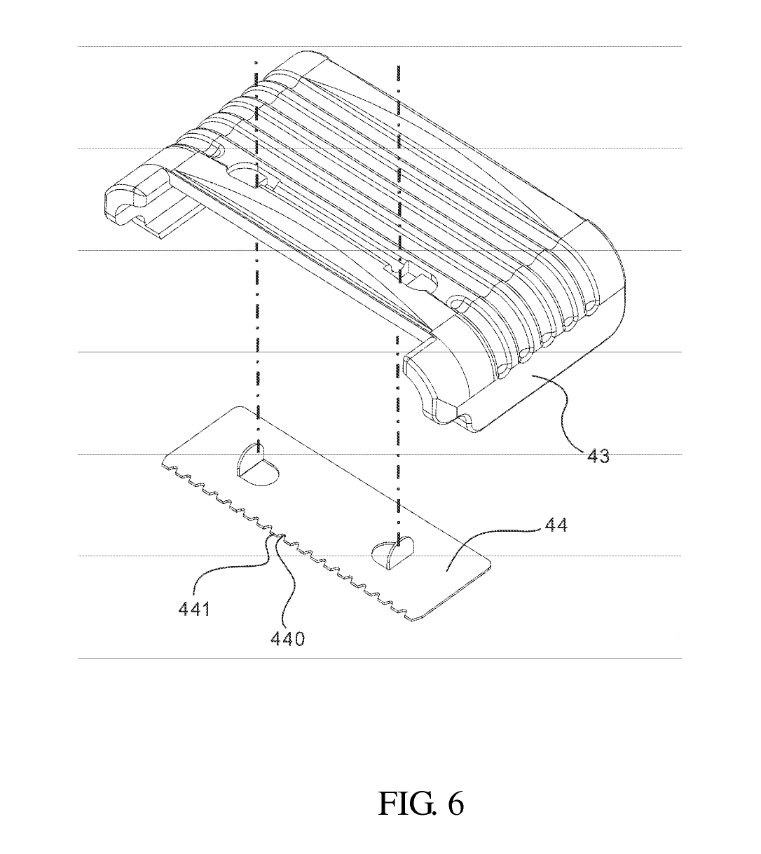

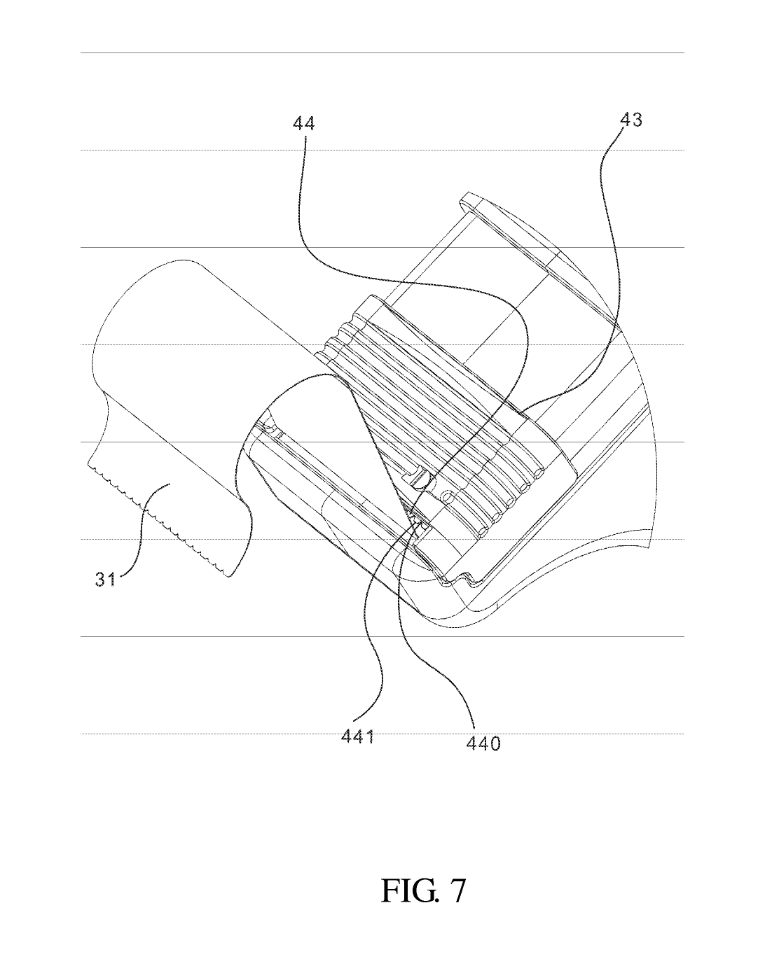

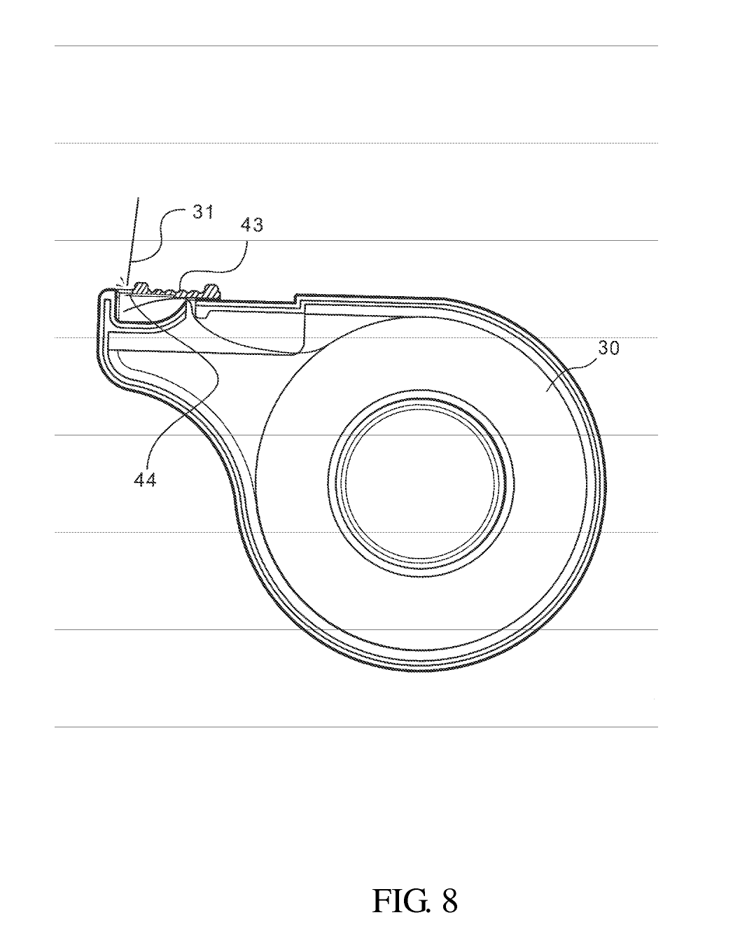

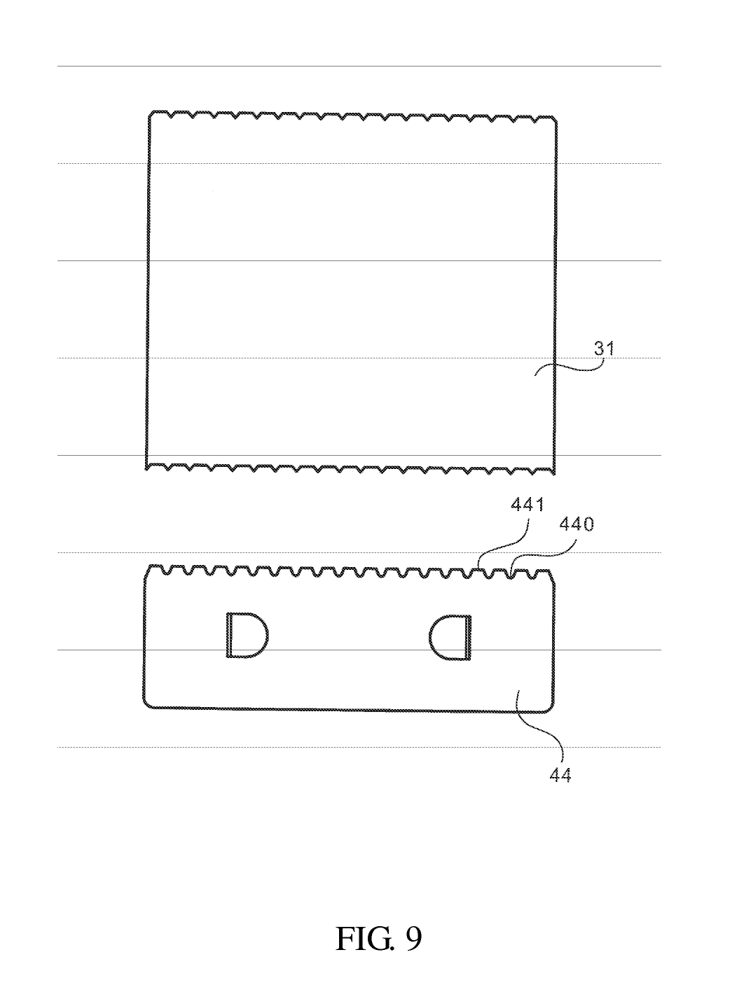

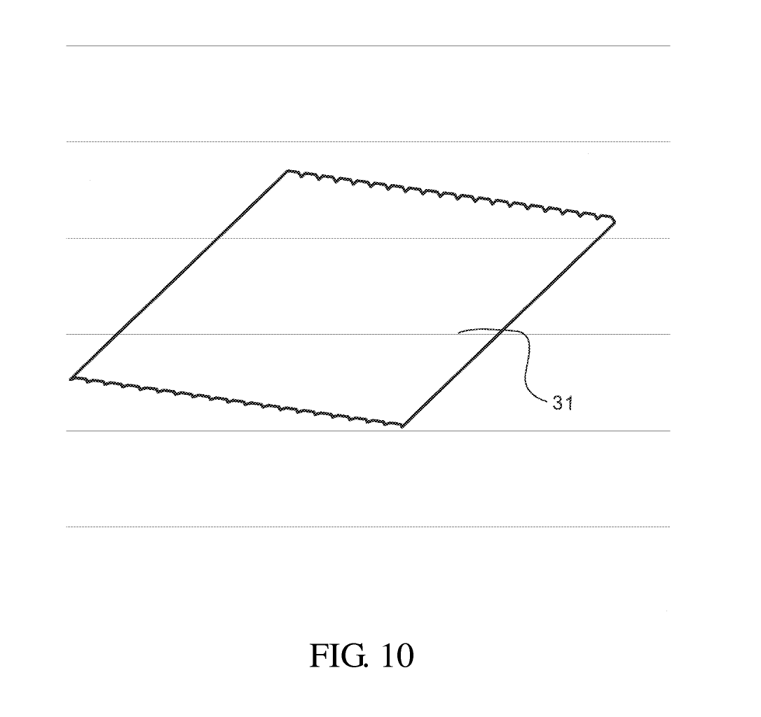

Referring to FIGS. 4 to 10, a tape cutter 40 incorporating a blade 44 in accordance with a preferred embodiment of the invention is shown. The tape cutter 40 comprises the following components as discussed in detail below.

A cutter body 40A comprises an opening 41 proximate to a forward end and a slot 42 adjacent the opening 41.

A complementary cutter body 40B comprises an opening 41 proximate to a forward end and a slot (not numbered) adjacent the opening 41 thereof.

A rectangular blade 44 has a plurality of truncated trapezoidal sharpened teeth 441 on one end. A triangular gap 440 is formed between any two adjacent teeth 441. The blade 44 is releasably secured to a sliding blade mount 43 formed of flexible plastic. The sliding blade mount 43 has two downward bent sides releasably secured to the slots 41 by snapping after securing the cutter body 40A to the complementary cutter body 40B. The openings 41 are thus assembled to form a cutter opening 41.

A tape roll 30 having an adhesive tape 31 wound thereon is mounted in the tape cutter 40. The tape roll 30 has one end slightly pulled out of the cutter opening 41 in a ready to use position. Also, there is a small distance (i.e., gap) between the tape 31 and the teeth 441.

In use a person may pull a desired length of the tape 31 out of the cutter opening 41. Next, the person may slide the sliding blade mount 43 to cause the teeth 441 to cut the pull out portion of the tape 31. Advantageously, the severed end of the cut out portion of the tape 31 has a uniformed edge after application of the tape 31. This is because the teeth 441 have a decreased length, the gaps 440 are relatively wide, and together they are capable of smoothly guiding the severed end of the cut out portion of the tape 31. This has the benefits of being visually attractive, easy of applying the adhesive side of the tape 31 onto an object to be sealed, and capable of cutting out adhesive tapes formed of foam or fiber.

While the invention herein disclosed has been described by means of specific embodiments, numerous modifications could be made thereto by those skilled in the art without departing from the scope and spirit of the invention set forth in the claims.

What is claimed is:

1. A blade of a tape cutter comprising a plurality of truncated trapezoidal sharpened teeth on one end wherein a substantially triangular gap is formed between any two adjacent teeth.
